(19) United States
(12) Patent Application Publication
(10) Pub. No.: US 2012/0255852 A1
(43) Pub. Date: Oct. 11, 2012

(54) REACTION PROCESS USING SUPERCRITICAL WATER

(76) Inventors: Masayuki KAMIKAWA, Hitachinaka (JP); Toshiaki Matsuo, Mito (JP); Kenichiro Oka, Mito (JP); Takeyuki Kondo, Hitachi (JP); Yasunari Sase, Tokyo (JP); Masashi Tanto, Tokyo (JP); Hiroyuki Ito, Tokyo (JP)

(21) Appl. No.: 13/437,960

(22) Filed: Apr. 3, 2012

(30) Foreign Application Priority Data
Apr. 5, 2011 (JP) 2011-083558

(51) Int. Cl. B01D 3/14

(52) U.S. Cl. 203/21; 202/161

(57) ABSTRACT

When obtaining a target substance by gradually cooling the reaction liquid by cooling in a plurality of stages divided in series, and then distilling the cooled reaction liquid by distillation in a plurality of stages divided in series, this method and this apparatus include: circulating a heating medium to be used for cooling in the plurality of the stages by way of; sequentially passing the heating medium toward the most upstream cooling stage from the most downstream cooling stage of the reaction liquid; cooling the heating medium which has been discharged from the most upstream cooling stage by using the heating medium for keeping or raising the temperature of the liquid which has been discharged from the distillation in the plurality of the stages; and returning the cooled heating medium back to the most downstream cooling stage of the reaction liquid.

### BACKGROUND OF THE INVENTION

1. Field of the Invention

The present invention relates to a method or an apparatus for obtaining a target substance by cooling a reaction liquid obtained by making an organic compound of a raw material react with an acid under the presence of hydrogen ions in supercritical water and distilling the cooled reaction liquid, and particularly relates to a method and an apparatus for synthesizing acrolein from glycerol.

2. Background Art

Because 1,3-propanediol is a raw material of a polyester fiber of high quality, which includes polytrimethylene terephthalate (PTT), the demand is growing in recent years. As one of methods for synthesizing 1,3-propanediol, there is an acrolein hydration and hydrogenation method described in Production, applications and economic efficiency of 1,3-PDO and PTT, CMC Publishing Co., Ltd., Planet Division, August, 2000. This method is a production method of subjecting acrolein which has been synthesized by oxidizing propylene that is a raw petroleum material with air under the presence of a catalyst, to a hydration/hydrogenation reaction, and is established as an industrial production method. However, it is desired in recent years to develop a method of synthesizing 1,3-propanediol from a biological raw material, on the background of a remarkable rise of an oil price.

A method for synthesizing 1,3-propanediol from a biological raw material with a chemical synthesis process is not reported, but a technology for synthesizing acrolein which is a precursor thereof exists. For instance, there is a technology described in M. Watanabe, et al., Acrolein synthesis from glycerol in hot-compressed water, Bioresource Technology (Elsevier Ltd.) 98 (2007) pp. 1285-1290 as one of the technologies. The method described in M. Watanabe, et al., Acrolein synthesis from glycerol in hot-compressed water, Bioresource Technology (Elsevier Ltd.) 98 (2007) pp. 1285-1290 is a method of synthesizing acrolein by using glycerol which is a biological raw material as a starting material, and using a supercritical water of 400° C. at 35 MPa. The method has a feature in a point that a proton originating from a very small quantity of sulfuric acid added into the supercritical water functions as a co-catalyst for accelerating the dehydration reaction of glycerol. However, this method has a possibility of producing a mixture of tar and carbon particles as a by-product by thermal cracking, and causing blockage in a pipe and/or a valve. For this reason, in order to reduce the production amount of the by-product, the raw material needs to be controlled to low concentration, but as a result of this, the energy and cost per production amount become enormous, which are consumed because of being necessary for raising the temperature and pressure of water, and the industrialization which conducts mass production has been in a difficult situation.

JP Patent Application Publication No. 2000-279976 is reported as an example of a supercritical reaction apparatus in which solid particles that include mainly salts are considered so as to be removed. The technology described in JP Patent Application Publication No. 2000-279976 has been created on the background of the fact that salts have high solubility in water in a state at room temperature and normal pressure because the water has high relative permittivity in the state, but the salts tend to easily deposit in a supercritical state because of the lowering of the relative permittivity. In order to reduce the blockage in a pipe due to a solid matter of salts, which has deposited because of having exceeded its solubility in supercritical water, this technology adopts a method of separating and collecting the solid matter with a hydrocyclone installed in the middle of the pipe. However, it is considered to be difficult to apply even the above described method simply to a by-product which is dealt with as an object in the present invention. This is because the by-product contains tar having high viscosity and adhesive properties, and the deposition of the by-product in a pipe and an apparatus for removing solid particles hinders the operation.

There is JP Patent Application Publication No. 2010-184897 as an invention which realizes a smooth operation as a method of synthesizing acrolein from glycerol, by removing carbon particles and tar from a reaction liquid. This invention deals with a technology of removing carbon particles, by stopping an acrolein production reaction by injecting a cooling water into a reaction liquid, subsequently passing the resultant reaction liquid through a filter, then removing tar by cooling and decompressing the reaction liquid, further cooling the reaction liquid, and subsequently distilling the reaction liquid. However, there has been a problem that the amount of cooling water to be used for stopping the reaction is large and energy consumption necessary for re-cooling the cooling water which has been used for the cooling is large, because a plurality of coolers of which the cooling temperatures are different are provided in the apparatus.

### SUMMARY OF THE INVENTION

An object of the present invention is to provide a technology of: reducing the amount of thermal energy to be used therein by efficiently cooling a reaction liquid obtained by making an organic compound of a raw material react with an acid under the presence of hydrogen ions in supercritical water and heating water discharged after distillation; reducing the amount of water to be used therein by separating water from a by-product and recycling the separated water as a raw material and cooling water; and enabling the operation cost of a plant to be reduced.

In order to solve the above described problems, a method or an apparatus according to the present invention is the method or the apparatus for obtaining a target substance by gradually cooling a reaction liquid obtained by making an organic compound of a raw material react with an acid in supercritical water, by cooling with the use of coolers in a plurality of stages divided in series, and then distilling the cooled reaction liquid, by distillation with the use of distillation towers in a plurality of stages connected in series, and includes circulating a heating medium to be used for cooling in the plurality of the stages by way of: sequentially passing the heating medium toward the upstream cooling stage from the downstream cooling stage of the reaction liquid; cooling the heating medium which has been discharged from the upstream cooling stage by using the heating medium for keeping or raising the temperature of the liquid which has been discharged from the distillation towers in the plurality of the stages; and returning the cooled heating medium back to the most downstream cooler.

In addition to the above described features, the method or the apparatus according to the present invention further includes circulating water in such a way as to use the water obtained through a process of removing a solid content, an organic matter and an acid from a flowing liquid which has been discharged from the most upstream distillation stage out of the plurality of the distillation stages, as a raw material water or a cooling water for reaction quenching for the purpose of stopping the reaction.

In addition, in the method or the apparatus, the organic compound of the raw material is glycerol, and the target substance is acrolein.

The method or the apparatus according to the present invention for obtaining a target substance by gradually cooling a reaction liquid obtained by making an organic compound of a raw material react with an acid under the presence of hydrogen ions in supercritical water with the use of coolers in a plurality of stages divided in series, and then distilling the cooled reaction liquid with the use of distillation towers in a plurality of stages connected in series, can reduce the amount of thermal energy to be used therein and the amount of water to be used therein, and accordingly can achieve excellent economical efficiency such as a high utilization factor of the raw material and a low operation cost of a plant.

### BRIEF DESCRIPTION OF THE DRAWINGS

FIG. 1 is a view illustrating one example of the case in which glycerol is used as an organic compound of a raw material, sulfuric acid is used as an acid and acrolein is determined to be a target substance, in an embodiment of an apparatus according to the present invention for obtaining the target substance by gradually cooling a reaction liquid obtained by making the organic compound of the raw material react with supercritical water and the acid, by cooling in a plurality of stages divided in series, and then by distilling the cooled reaction liquid in a plurality of stages divided in series.

### DETAILED DESCRIPTION OF THE PREFERRED EMBODIMENTS

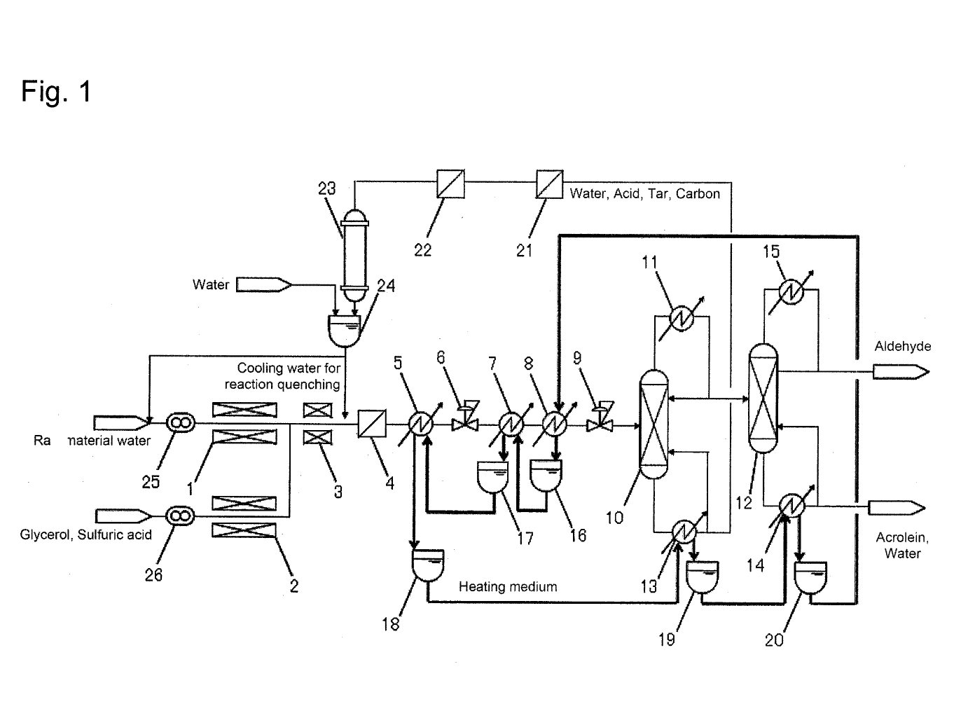

An embodiment of the present invention will be described below with reference to FIG. 1. An apparatus for synthesizing the organic matter using supercritical water according to the embodiment of the present invention has: a first heater 1, a second heater 2, a third heater 3, a filter 4, a first cooler 5, a first decompression valve 6, a second cooler 7, a third cooler 8, a second decompression valve 9, a first distillation tower 10, a heat exchanger 11, a second distillation tower 12 and a reboiler 14 which are arranged from the upstream side of a reaction path in this order, as is illustrated in FIG. 1, and is directed at obtaining a target organic matter through the above reaction paths.

FIG. 1 illustrates one example of apparatuses specifically for synthesizing acrolein by a reaction of making glycerol of an organic compound of a raw material react with supercritical water and sulfuric acid as an acid, for the embodiment of the present invention.

The apparatus for synthesizing acrolein illustrated in FIG. 1 divides a cooling process to be conducted after the reaction of making the glycerol react with the supercritical water which has been pressurized to 22 to 50 MPa and with the acid, by a first pump 25 and a second pump 26; cools (first cooling) a reaction liquid obtained by making the glycerol react with the supercritical water and the acid, to a temperature at which a main reaction is stopped and a high-viscosity component such as tar contained in the reaction liquid can be kept in a state of having sufficiently lowered the viscosity, by injecting cooling water for reaction quenching thereby to reduce the production amount of a by-product and control a high-viscosity component such as tar so as not to increase its viscosity and adhesive properties; and accordingly can keep a state in which a solid content such as a carbon particle does not cause agglomeration.

The solid content in a non-agglomerating state has particle sizes of several μm to several tens μm, has also extremely small adhesive properties, and accordingly does not cause blockage in a pipe. In addition, the apparatus can reduce such an effect that a differential pressure increases due to the deposition of the solid matter on the separation face, also in an operation of separating and removing the solid matter. Because of this, the frequency of the switching of a plant operation system and the maintenance of a separation apparatus such as a filter backwashing operation is remarkably reduced, energy loss originating in a stopping and restarting operation is reduced, and accordingly the operation cost can be reduced.

In addition, the apparatus cools the reaction liquid in a high temperature such as 400° C., then separates the solid content, and accordingly can prevent the heat deterioration of the separation apparatus. The reaction liquid after the first cooling process desirably has a viscosity of 0.1 Pa·s or less, and needs to be controlled to such a temperature as to be capable of achieving the low viscosity at that level, specifically, to 100° C. or higher. On the other hand, because a temperature of 200° C. or lower is desirable for completely stopping the synthetic reaction and the thermal decomposition reaction, the cooling temperature in the first stage is desirably 100 to 200° C.

The apparatus directly mixes cooling water into the reaction liquid as a cooling method in the first cooling step, and thereby can change the temperature at a higher speed than that in heat exchange from the periphery of the pipe with the use of a jacket or the like. Thereby, the apparatus can stop the thermal decomposition reaction at a high speed, can stop the produced acrolein from changing into the by-product such as tar and carbon particles, and accordingly enables an enhancement of a yield of a raw material to be expected. In addition, the amount of the by-product to be produced can be reduced, which thereby contributes to reducing the blockage in a pipe and equipment and the occurrence of erosion and to precise pressure control.

Next, the apparatus separates and removes the solid content from the reaction liquid, then cools the resultant reaction liquid to a temperature which is a boiling point of water or lower and at which a tar content in the reaction liquid does not adhere to the equipment, by using the first cooler 5, and then decompresses the cooled reaction liquid by using the first decompression valve 6. Thereby, the apparatus can avoid blockage in a pipe and a valve caused by the solid content, and also can reduce the deposition of the tar content, which consequently enhance accuracy in controlling the pressure in the first decompression valve 6. Because the opening of the decompression valve is extremely narrow in particular, it is extremely effective to reduce the deposition not only of the tar content but also of the solid content, in order to facilitate and stabilize the opening/closing operation of the valve.

In addition, the apparatus sets the cooling temperature at the boiling point of water or lower, thereby can suppress a rapid expansion of the volume of the reaction liquid, which is caused by the evaporation of the reaction liquid after having been decompressed, and accordingly can enhance the safety of the reaction apparatus. The reaction liquid after having been cooled by the first cooler 5 desirably has a viscosity of 10 Pa·s or less, and needs to be controlled to such a temperature as to be capable of achieving the low viscosity at this level, specifically to 53° C. or higher and desirably to 80° C. or higher. On the other hand, the temperature is desirably 100° C. or lower, from the viewpoint of reducing the evaporation and rapid expansion of the reaction liquid after having been decompressed. Because of this, the cooling temperature in the second stage needs to be considered to be the boiling point of the acrolein at the lowest or higher, and shall be 53 to 100° C. and desirably 80 to 100° C.

The apparatus cools the reaction liquid to the boiling point of the target reaction substance by using the second cooler 7 and the third cooler 8 after having decompressed the reaction liquid, in other words, keeps the temperature in the cooling step with the use of the second cooler 7 and the third cooler 8 at the boiling point or higher. Thereby, the target substance easily evaporates from the discharged reaction liquid. Because of this, the apparatus can enhance the energy efficiency to be obtained when the reaction liquid is reheated in a distillation step in a later stage. The temperature in this cooling step shall be in a range of 53° C. to the cooling temperature of the first cooler 5 so that the temperature becomes the boiling point of acrolein or higher when acrolein is synthesized. The cooled reaction liquid is decompressed by the second decompression valve 9, and then is sent to the first distillation tower 10.

When a process from the reaction to the separation and removal of the solid content is conducted in a horizontal system, the solid content in a produced by-product deposits in the bottom of the pipe, and erosion occurs in the bottoms of the pipe, the decompression valve and the like. Then, when this process is conducted in vertical pipes divided by the valve, the reaction liquid containing the by-product flows down uniformly with respect to a peripheral direction of the pipe due to the gravitational force. Accordingly, solid particles smoothly come in contact with the inner face of the pipe, and a further effect of reducing the erosion can be obtained.

In addition, two or more systems of the reaction apparatus and a solid-content separation apparatus are prepared between the heater 1 and the filter 4, which enables an alternating operation and an alternating discharge of the by-product particles. Specifically, when a maintenance operation is conducted in some systems, the apparatus can keep the state in which at least one of the other systems is operated, does not need to stop the whole plant, and can be continuously operated. On this occasion, the first heater 1 in the front stage of the reaction apparatus has a longer staying period of time and a larger facility scale than those in the third heater 3 for a reaction pipe.

In addition, the organic matter such as glycerol which is a raw material does not pass through the first heater 1, and accordingly the by-product is not produced there. It is understood from this that the heater 1 has an extremely smaller possibility of causing a trouble originating in the by-product than that in steps in the downstream side, in spite of using a large ratio of energy in the whole process. Then, it becomes possible to reduce both of the facility cost and the operation cost, by arranging the heater 1 having a large facility scale so as to be commonly used for each system and a plurality of systems so as to be branched from the reaction pipe, when the types of the plurality of the systems are designed, and thereby enabling the heater 1 to be continuously operated, so as to minimize the energy loss due to the stopping/restarting of the heater.

The reaction liquid which has flowed into the first distillation tower 10 is separated by distillation into a reaction liquid, which contains acrolein, water, acetaldehyde, formaldehyde and the like and is discharged from the top, and into waste water, which contains water, sulfuric acid, tar and the like and is discharged from the bottom. The reaction liquid is cooled by the heat exchanger 11, and then flows into the second distillation tower 12. The reaction liquid which has flowed into the second distillation tower 12 is separated by distillation into waste water, which contains the acetaldehyde and the formaldehyde and is discharged from the top, and into a reaction liquid, which contains the acrolein and is discharged from the bottom. The reaction liquid discharged from the second distillation tower 12 flows into the reboiler 14, and when the acrolein is subjected to the hydration reaction, is heated to a temperature of 40 to 70° C. which is in the vicinity of the reaction temperature of a hydration reaction, and desirably of 50 to 60° C.

When the above described divisional-cooling method is used for a reaction of synthesizing acrolein by making glycerol react with supercritical water and an acid, the cooling temperature of the first cooler 5 is set at 100 to 200° C., the cooling temperature of the second cooler 7 is set at 53 to 100° C., and the cooling temperature of the third cooler 8 is set at 53° C. to the second cooling temperature. When these coolers are individually operated, a heating medium of which the temperature has been raised by cooling for the reaction liquid needs to be cooled, and the individual heating/cooling operations for the heating medium result in being repeated, which is consequently inefficient. Then, it becomes possible to reduce the energy consumption, by decreasing the width of the temperature control for the heating medium by connecting circulation paths of the heating medium in each cooler and circulating the heating medium from the third cooler 8 in the downstream side of the process to the second cooler 7 and further from the second cooler 7 to the first cooler 5. The heating medium discharged from the first cooler 5 is sent to the buffer tank 18, and the temperature is controlled therein. The heating medium of which the temperature has been controlled is supplied to the reboiler 13, and keeps the waste water warm there which has been discharged from the bottom of the distillation tower 10 and contains the acid and the tar, so as to keep the flowability.

The waste water which is heated in the reboiler 13 is kept in a temperature range of 50 to 100° C. and desirably of 80 to 100° C., in order that the flowability is kept. On the other hand, the heating medium discharged from the reboiler 13 is sent to the buffer tank 19, and the temperature is controlled therein. Then, the heating medium of which the temperature has been controlled is supplied to the reboiler 14, and raises the temperature of the reaction liquid which has been discharged from the bottom of the second distillation tower 12 and contains acrolein. The reaction liquid which is heated by the reboiler 14 is desirably raised to the reaction temperature of the hydration reaction in the post process. The temperature range is 40 to 70° C., and desirably is 50 to 60° C. On the other hand, the heating medium discharged from the reboiler 14 is sent to the buffer tank 20, the temperature is controlled therein, and then the resultant heating medium is supplied to the cooler 8 again.

The waste water which has been kept warm in the reboiler 13 and contains tar, sulfuric acid and the like flows into a solid-content separation apparatus 21, and the solid content is separated there. The waste water is kept in a temperature range of 50 to 100° C. and desirably of 80 to 100° C., in order that the flowability is kept, and accordingly the solid matter such as the carbon particles is collected in the solid-content separation apparatus 21, but it is suppressed for the high-viscosity component such as the tar to deposit on the solid-content separation apparatus 21. A filter, a cyclone and a sedimentation tank or the like can be used for the separation of the solid content.

The waste water discharged from the solid-content separation apparatus 21 flows into an organic-content removal apparatus 22, and the organic matter in the waste water is removed here. The organic-content removal apparatus removes the organic matter by adsorption, and usable adsorbents include activated carbon and zeolite. Thereby, the tar and the other organic matters contained in the waste water are removed. The waste water discharged from the organic-content removal apparatus 22 flows into an ion exchange column 23, and acids such as sulfuric acid contained in the waste water are removed here by an ion exchange resin.

The above described water which has been purified through the processes from the solid-content separation apparatus 21 to the ion exchange column 23 flows into a water tank 24, and is recycled as a raw material water or a cooling water for reaction quenching. Thereby, the amount of water to be used can be reduced, and accordingly the operation cost of the plant can be suppressed. In addition, a waste water treatment facility becomes unnecessary which has been necessary for discharging the waste water containing a chemical substance designated as a poisonous substance such as the acrolein and the formaldehyde to the outside of the system, and accordingly the apparatus can also contribute to reduce the facility cost and the operation cost. Furthermore, the apparatus enables an alternating operation and an alternating discharge of impurities by preparing two or more systems between the solid-content separation apparatus 21 and the ion exchange column 23. Accordingly, when a maintenance operation for some systems is conducted, the apparatus can keep the state in which at least one of the other systems is operated, which enhances the continuous operability of the whole plant.

In the case of the above described reaction of synthesizing acrolein by employing glycerol which is a biological raw material as an organic compound of a raw material and making the glycerol react with supercritical water and an acid such as sulfuric acid, polytrimethylene terephthalate (PTT) can be produced which is one of high-grade polyesters to be used for a fiber or the like, by further subjecting the acrolein to a hydration reaction and then subjecting the hydrated acrolein to a hydrogenation reaction to convert the acrolein into 1,3-propanediol, and polymerizing the 1,3-propanediol with terephthalic acid. Accordingly, the apparatus can use a raw material originating from biomass for one part of a raw material for the PTT which is noticed as a dreamy thread that is soft and has extensibility and recoverability. Thereby, the consumption of the fossil fuel having a limit in the amount of deposit can be reduced.

One example of the above described embodiment according to the present invention will be described below, but the scope of the present invention is not limited to this example.

### Example

Acrolein was synthesized by basically using the apparatus illustrated in FIG. 1 on conditions that a supercritical reaction was conducted at 400° C. and 35 MPa, the reaction liquid was cooled to 200° C. by quenching by the injection of cooling water, the reaction liquid was cooled to 125° C. from 200° C. by the first cooler 5, the cooled reaction liquid was decompressed to 0.35 MPa from 35 MPa by the first decompression valve 6, the decompressed reaction liquid was cooled to 95° C. from 125° C. by the second cooler 7, the cooled reaction liquid was cooled to 60° C. from 95° C. by the third cooler 8, and the cooled reaction liquid was decompressed to atmospheric pressure by the second decompression valve 9, a concentration of glycerin of a raw material was set at 15 wt %, a reaction temperature was set at 400° C., a reaction pressure was set at 35 MPa and a reaction period of time was set at 2 seconds (s).

As a result, in the obtained reaction liquid, a yield of the acrolein was 70%, the separation efficiency for the solid matter by the filter 4 was 95%, the separation efficiency for the solid content by the solid-content separation apparatus 21 with the use of the filter was 99%, a removal efficiency by the organic-content removal apparatus 22 with the use of activated carbon was 99%, the removal efficiency for sulfuric acid by the ion exchange column 23 was 99%, and a recovery rate of water from the waste water discharged from the bottom of the first distillation tower 10 was 90%. The liquid produced by the thermal decomposition of the tar and the like was analyzed with a gas chromatography (GC) analysis, was proved to contain molecules having 10 to 50 carbon atoms, and had melt viscosities of 300, 10, 1 and 0.1 Pa·s or less at 70, 80, 90 and 100° C., respectively.

In the experiment of the present example, the reaction liquid was mixed with the same amount of the cooling water to lower the temperature to approximately 200° C., and the mixture was passed into a 3 μm filter made by Swagelok Company. However, at this time, the differential pressure of the filter did not increase and the carbon particles having a diameter of approximately 10 μm were separated and removed with 95% efficiency. After the experiment was finished, the deposition of the solid matter and the tar was not observed on the surface of the filter, and there was no problem in particular.

In the present experiment, such an operation was further conducted as to pass the reaction liquid from which the carbon particles were separated and removed, into a double pipe having a length of 1 m, lower the temperature of the reaction liquid to 80° C. by indirectly cooling the reaction liquid with cooling water, and lower the pressure to 5 MPa or less with a decompression valve. After the experiment was finished, the deposition of the solid matter and the tar was not observed in the inner part of the double pipe and the decompression valve. Furthermore, in the present experiment, the reaction liquid was passed into a double pipe, the temperature of the reaction liquid was lowered to 53° C. by indirect cooling with the use of cooling water, and the cooled reaction liquid was discharged to the outside of the system. Thereby, vapor was generated which contained acrolein and a small amount of entrained water, and an aqueous solution containing a high-concentration of acrolein was collected by an operation of condensing the vapor.

### Comparative Example

Acrolein was synthesized with the same parameter as that in Example 1. However, the heating medium was not circulated in such a way as to be passed from the hot temperature side of the plurality of the coolers and be returned to the low temperature side of the plurality of the coolers through the reboiler, but was individually cooled or heated. In addition, the waste water which was extracted from the bottom of the distillation tower 10 was disposed. As a result, the amount of used water increased to 11.0 times, and the thermal energy increased to 3.8 times, in comparison with those in Example 1.

As described above, the method or the apparatus according to the present invention for obtaining a target substance by gradually cooling a reaction liquid obtained by making glycerol react with sulfuric acid under the presence of hydrogen ions in supercritical water, with coolers in a plurality of stages divided in series, and then by distilling the cooled reaction liquid with distillation towers in a plurality of stages connected in series, includes circulating a heating medium (for instance, cooling water) by raising the temperature of the heating medium by passing the heating medium to the upstream side of the plurality of the coolers from the downstream side, then cooling the heating medium of which the temperature has been raised by using the heating medium for keeping the temperature of the liquid after distillation at the temperature or raising the temperature of the liquid, and then passing the heat medium to the downstream side of the plurality of the coolers again. Thereby, the heating medium of which the temperature has been raised by the cooler radiates the heat in the reboiler, and accordingly the amount of thermal energy to be used can be reduced in comparison with the case in which these coolers and the reboiler are individually cooled or heated. In addition, the method or the apparatus includes removing a solid content, an organic matter and an acid from water containing the solid content, the organic matter and the acid, which is discharged from the bottom of the first distillation tower out of a plurality of distillation times, and using the resultant water as a raw material water or a cooling water for reaction quenching. Thereby, the amount of water to be used can be reduced. Because of this, the method or the apparatus can achieve such excellent economical efficiency that a utilization factor of the raw material is high and an operation cost of a plant is low.

### DESCRIPTION OF SYMBOLS

1 First heater
2 Second heater
3 Third heater
4 Filter
5 First cooler
6 First decompression valve
7 Second cooler
8 Third cooler
9 Second decompression valve
10 First distillation tower
11 Heat exchanger
12 Second distillation tower
13 Reboiler
14 Reboiler
15 Heat exchanger
16 Buffer tank
17 Buffer tank
18 Buffer tank
19 Buffer tank
20 Buffer tank
21 Solid-content separation apparatus
22 Organic-content removal apparatus
23 Ion exchange column
   Water tank
   First pump
   Second pump

What is claimed is:

1. A method for obtaining a target substance by gradually cooling a reaction liquid obtained by making an organic compound of a raw material react with an acid in supercritical water, by cooling in a plurality of stages divided in series, and then by distilling the cooled reaction liquid by distillation in a plurality of stages divided in series, comprising
circulating a heating medium to be used for cooling in the plurality of the stages by way of: sequentially passing the heating medium toward the upstream cooling stage from the downstream cooling stage of the reaction liquid; cooling the heating medium which has been discharged from the upstream cooling stage by using the heating medium for keeping or raising the temperature of the liquid which has been discharged from the distillation in the plurality of the stages; and returning the cooled heating medium back to the downstream cooling stage of the reaction liquid.

2. The method according to claim 1, further comprising
circulating water in such a way as to use the water obtained through a process of removing a solid content, an organic matter and an acid from a flowing liquid which has been discharged from the upstream distillation stage out of distillation towers in the plurality of the stages, as a raw material water or a cooling water for reaction quenching for the purpose of stopping the reaction.

3. The method according to claim 1 or 2, wherein
the organic compound of the raw material is glycerol, and the target substance is acrolein.

4. An apparatus for obtaining a target substance by gradually cooling a reaction liquid obtained by making an organic compound of a raw material react with an acid in supercritical water, by cooling in a plurality of stages divided in series, and then distilling the cooled reaction liquid by distillation in a plurality of stages divided in series, comprising:
coolers in the plurality of the stages, which cool the reaction liquid;
distillation towers in the plurality of the stages, which are connected to a downstream side of the coolers; and
reboilers formed in discharge passages from the distillation towers in the plurality of the stages, wherein
a circulation passage of a heating medium is arranged so as to sequentially communicate toward the upstream cooler from the downstream cooler out of the coolers in the plurality of the stages and return to the downstream cooler from the upstream cooler via the reboilers.

5. The apparatus according to claim 1, further comprising
a solid-content separation apparatus, an organic-content removal apparatus and an ion exchange column, wherein
a channel is arranged which passes through the distillation tower in the upper stage out of the distillation towers in the plurality of the stages, the reboiler, the solid-content separation apparatus, the organic-content removal apparatus and the ion exchange column, and reaches a water tank which supplies a raw material water of the supercritical water or a cooling water for reaction quenching for the purpose of stopping the reaction.

6. The apparatus according to claim 4 or 5, wherein
the organic compound of the raw material is glycerol, and the target substance is acrolein.
